(19) United States
(12) Patent Application Publication
(10) Pub. No.: US 2025/0232691 A1
(43) Pub. Date: Jul. 17, 2025

(54) DENTAL MODEL

(71) Applicant: NISSIN DENTAL PRODUCTS INC., Kyoto (JP)

(72) Inventors: Koshiro MATSUO, Kameoka-shi (JP); Atsushi TASHIRO, Kameoka-shi (JP); Masahiro HOSOYA, Kameoka-shi (JP); Teruyuki IWASAKI, Kameoka-shi (JP)

(73) Assignee: NISSIN DENTAL PRODUCTS INC., Kyoto (JP)

(21) Appl. No.: 18/730,977

(22) PCT Filed: Jan. 25, 2022
(86) PCT No.: PCT/JP2022/002666

§ 371 Date: Jul. 22, 2024

(51) Int. Cl. G09B 23/28; A61C 13/34

(52) U.S. Cl. CPC G09B 23/283; A61C 13/34

(57) ABSTRACT

The purpose of the present invention is to provide a dental model suitable for practical training when a lesion occurs in each region. A dental model 1 according to the present invention comprises: a teeth base part 10; an alveolar bone part 20 that is attachable to and detachable from the teeth base part 10 and provided with a plurality of insertion holes 23; a gum part 30 that is attachable to and detachable from the alveolar bone part 20 and provided with a plurality of insertion through-holes 33 at positions overlapping openings of the insertion holes 23; and a plurality of model teeth 40 that are directly attachable to and detachable from the insertion holes 23, respectively, in a state where the gum part 30 is not attached to the alveolar bone part 20 and are, through the insertion through-holes 33, attachable to and detachable from the insertion holes 23, respectively, in a state where the gum part 30 is attached to the alveolar bone part 20, and each have a tooth crown part 41 that is exposed from the insertion hole 23 and a tooth root part 42 that is inserted in the insertion hole 23 when being inserted in the insertion hole 23. The plurality of insertion holes 23 include a branch insertion hole 23A the interior of which branches into a plurality of branch holes, and the model teeth 40 include a branch model tooth 40A the tooth root part 42 of which branches into a plurality of branch root parts to be respectively inserted in the branch holes.

### TECHNICAL FIELD

The present invention relates to a dental model.

### BACKGROUND ART

A dental model is used, for example, in a case of providing various types of practical training in a dental educational institution (dental university, hygienist school, dental technician school), a dental clinic, and a dental seminar. A conventional dental model includes model teeth having crown portions and root portions, a tooth base configured such that insertion holes in which the root portions of the model teeth are fittable are arranged along a dentition, and a model gum configured such that insertion through-holes in which the root portions are fittable are arranged along the dentition. The insertion hole and the insertion through-hole communicate with each other, and the root portion of the model tooth is inserted into the insertion hole and the insertion through-hole (see Patent Document 1).

### PATENT DOCUMENT

Patent Document 1: Japanese Unexamined Patent Application, Publication No. 2002-000628

### DISCLOSURE OF THE INVENTION

### Problems to be Solved by the Invention

However, the conventional dental model is different from the shape of actual teeth, and has a limitation as one for practical training in a case where a lesion is caused in a certain portion.

Thus, the present invention is intended to provide a dental model suitable for practical training in a case where a lesion is caused in a certain portion.

### Means for Solving the Problems

In order to solve the above-described problems, the present invention provides a dental model including a tooth base portion, an alveolar bone portion configured to be removably attachable to the tooth base portion and provided with a plurality of insertion holes, a gum portion configured to be removably attachable to the alveolar bone portion and provided with a plurality of insertion through-holes at positions overlapping with the openings of the insertion holes when the gum portion is attached to the alveolar bone portion, and a plurality of model teeth configured to be removably attachable to the insertion holes through the insertion through-holes in a state where the gum portion is attached to the alveolar bone portion and, when inserted into the insertion holes, the plurality of model teeth have crown portions exposed through the insertion holes and root portions inserted into the insertion holes. The plurality of insertion holes includes a bifurcated insertion hole bifurcated into a plurality of branch holes, and the model teeth include a bifurcated model tooth including a root portion that is bifurcated into a plurality of branch root portions to be inserted into the branch holes.

At least one of the branch holes in at least one of the insertion holes may be a through-hole, at least one of the branch root portions of the bifurcated model tooth, to be inserted into the through-hole may be provided with a screw hole which extends from the tip end to the crown portion side, a screw insertion through-hole may be provided in the tooth base portion at a position corresponding to the through-hole, and a screw may be screwable into the screw hole from the back of the tooth base portion through the screw insertion through-hole.

The at least one of the branch root portions of the bifurcated model tooth, provided with the screw hole may be the thickest one of the branch root portions of the bifurcated model tooth.

The alveolar bone portion has an alveolar bone side attachment surface to be removably attached to the tooth base portion, and the alveolar bone side attachment surface may be provided with an alveolar bone side step portion. The tooth base portion has a tooth base side attachment surface to which the alveolar bone portion is to be removably attached, and the tooth base side attachment surface may be provided with a tooth base side step portion in which the alveolar bone side step portion is to be fitted.

The length of the root portion of each model tooth corresponds to the length of a root portion of an actual tooth, the depth of each insertion hole of the alveolar bone portion may correspond to the length of the root portion to be inserted thereinto, and the alveolar bone side step portion may be provided corresponding to the depth of the each insertion hole.

Each model tooth may be configured such that the crown portion and the root portion differ in color from each other.

### Effects of the Invention

According to the present invention, the dental model suitable for practical training in the case where the lesion is caused in a certain portion can be provided.

### BRIEF DESCRIPTION OF THE DRAWINGS

FIG. 1 is a perspective view of an entire dental model 1 according to an embodiment of the present invention;

FIG. 2 is a perspective view of a lower dental model 1D;

FIG. 3 is an exploded perspective view of the lower dental model 1D;

FIG. 4 is a top view of an alveolar bone portion 20 with no model teeth 40 attached thereto;

FIG. 5 is a perspective view showing the alveolar bone portion 20 from below;

FIG. 6 is a view showing a state of the alveolar bone portion 20 being mounted on a tooth base portion 10;

FIG. 7 is a top perspective view of an alveolar bone portion 20 of an upper dental model 1U; and

FIG. 8 is a perspective view showing a model tooth 40 of the first molar in the upper dental model 1U.

### REFERRED MODE FOR CARRYING OUT THE INVENTION

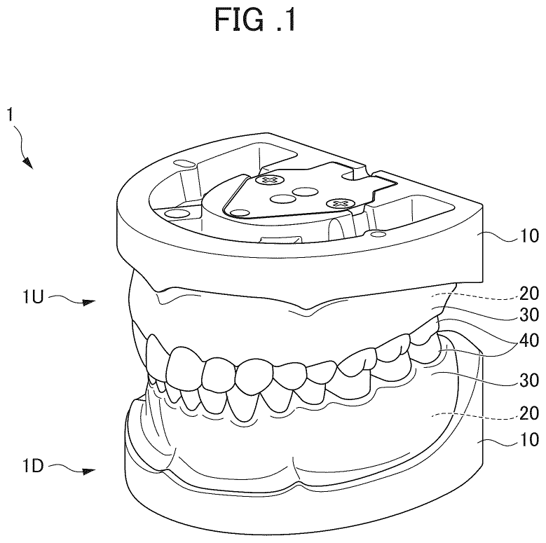

Hereinafter, an embodiment of the present invention will be described with reference to the drawings. FIG. 1 is a perspective view of an entire dental model 1 according to the embodiment of the present invention. The dental model 1 of the embodiment includes a lower dental model 1D and an upper dental model 1U. Note that the dental model 1 may include one of the lower dental model 1D or the upper dental model 1U.

### (Lower Dental Model 1D)

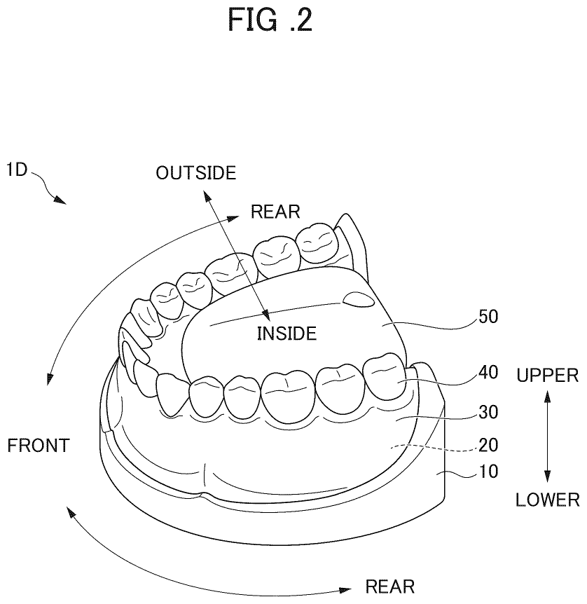

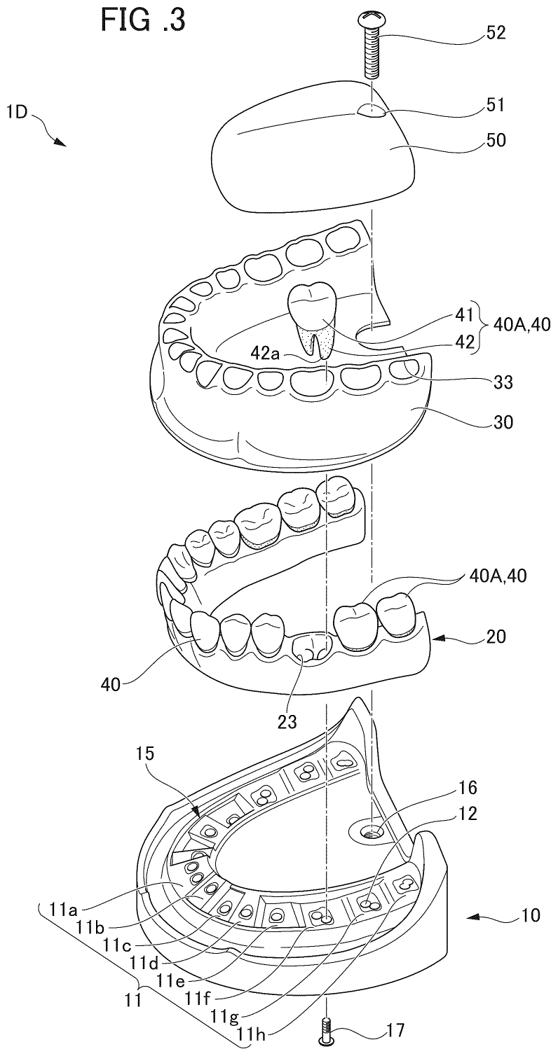

First, the lower dental model 1D will be described. FIG. 2 is a perspective view of the lower dental model 1D. FIG. 3 is an exploded perspective view of the lower dental model 1D. The lower dental model 1D includes a tooth base portion 10, an alveolar bone portion 20 that is removably attachable to the tooth base portion 10, a gum portion 30 that is removably attachable to the alveolar bone portion 20, a plurality of model teeth 40 that is removably attachable to the alveolar bone portion 20, and a tongue portion 50 that is removably attachable to the alveolar bone portion 20. FIG. 3 shows a state in which one model tooth 40 is detached and the remaining model teeth 40 are inserted into the alveolar bone portion 20.

Hereinafter, as shown in FIG. 2, in the dental model 1, a tongue side on which the tongue portion 50 is present will be described as inside, and the opposite side thereof, i.e., a side on which the cheeks and the lips are present in the case of an actual mouth, will be described as outside. Moreover, as shown in the figure, a front tooth side will be defined as a front side, and a back tooth side will be defined as a rear side. Further, regardless of the lower dental model 1D or the upper dental model 1U, the tooth base portion 10 side will be described as a lower side, and the model tooth 40 side will be described as an upper side.

### (Tooth Base Portion 10)

The tooth base portion 10 is a support having a substantially semi-elliptical shape in a section perpendicular to the upper-lower direction and configured such that the alveolar bone portion 20 is removably attachable to the tooth base portion 10 and the entirety of the lower dental model 1D is mountable on a flat surface. The tooth base portion 10 has a tooth base side attachment surface 15 to which the alveolar bone portion 20 is removably attachable, and the tooth base side attachment surface 15 is provided with tooth base side step portions 11 having a height difference and arranged in a U-shape along a dentition. The tooth base side step portions 11 are bilaterally symmetrical, and include eight steps on each of the right and left sides, i.e., 16 steps in total.

The eight tooth base side step portions 11 on each of the right and left sides include a tooth base side central incisor step portion 11a, a tooth base side lateral incisor step portion 11b dented (recessed) with respect to the tooth base side central incisor step portion 11a, a tooth base side canine step portion 11c dented with respect to the tooth base side lateral incisor step portion 11b, a tooth base side first premolar step portion 11d protruding with respect to the tooth base side canine step portion 11c, a tooth base side second premolar step portion 11e dented with respect to the tooth base side first premolar step portion 11d, a tooth base side first molar step portion 11f dented with respect to the tooth base side second premolar step portion 11e, a tooth base side second molar step portion 11g protruding with respect to the tooth base side first molar step portion 11f, and a tooth base side third molar step portion 11h protruding with respect to the tooth base side second molar step portion 11g in this order from the front side.

A screw insertion through-hole 12 is provided in each tooth base side step portion 11. A tooth fixing screw 17 can be inserted into the screw insertion through-hole 12 from below the tooth base portion 10, and can be screwed into a later-described screw hole 43 provided in the model tooth 40 attached to the alveolar bone portion 20.

Note that as shown in FIG. 3, there is a portion where two screw insertion through-holes 12 are formed in one tooth base side step portion 11. This is because the tooth base portion 10 is adapted for attachment thereto of both an alveolar bone portion to which a single rooted tooth abstracted as a model tooth can be attached and the alveolar bone portion 20 to which a bifurcated model tooth 40A having a clinical root as described in the embodiment can be attached. An optimal screw insertion through-hole 12 is different between the single rooted tooth and the bifurcated model tooth 40A, and for this reason, the two screw insertion through-holes 12 are provided. In the tooth base side third molar step portion 11h, the two screw insertion through-holes 12 are connected to each other to form a long hole because the positions of the two screw insertion through-holes 12 for the single rooted tooth and the bifurcated tooth are close to each other.

In the present embodiment, the two screw insertion through-holes 12 are connected to each other to form the long hole in the tooth base side third molar step portion 11h, but the portion with the long hole is not limited to the tooth base side third molar step portion 11h. That is, the long hole formed by connection of the two screw insertion through-holes may be formed in other tooth base side step portions. Three or more screw insertion through-holes may be formed in one tooth base side step portion, or these three or more screw insertion through-holes may be connected to each other to form a long hole. The shape of the screw insertion though-hole is not limited to a circular shape or a long hole shape. That is, the shape of the screw insertion through-hole may be a polygonal shape such as a rectangular shape or a triangular shape, or may be other shapes.

### (Alveolar Bone Portion 20)

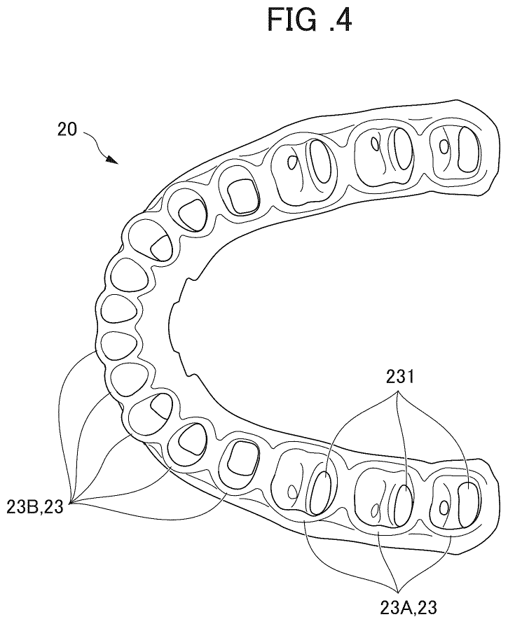

FIG. 4 is a top view of the alveolar bone portion 20 with no model teeth 40 attached thereto. The alveolar bone portion 20 corresponds to the actual alveolar bone, protrudes upward in a mountain shape, and has a U-shape in a section perpendicular to the upper-lower direction.

### (Insertion Hole 23)

A top portion of the mountain-shaped alveolar bone portion 20 is provided with a plurality of insertion holes 23 into which the plurality of model teeth 40 are insertable. The depth of the insertion hole 23 substantially corresponds to the length of a root portion 42 of the model tooth 40 to be inserted thereinto. The shape of the insertion hole 23 substantially corresponds to the shape of the root portion 42 of the model tooth 40 to be inserted thereinto. That is, the insertion holes 23 into which the model tooth 40 of the first molar, the model tooth 40 of the second molar, and the model tooth 40 of the third molar are to be inserted are bifurcated insertion holes 23A each of which is bifurcated into two branch holes, and the insertion holes 23 into which the other model teeth 40 are to be inserted are non-bifurcated insertion holes 23B. The largest branch hole of at least one bifurcated insertion hole 23A is a through-hole 231.

### (Alveolar Bone Side Step Portion 21)

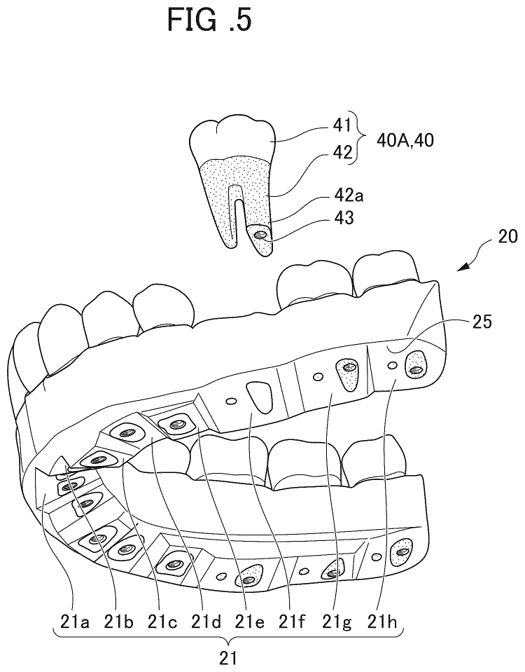

FIG. 5 is a perspective view showing, from below, the alveolar bone portion 20 in a state in which one model tooth 40 is detached and the remaining model teeth 40 are inserted into the alveolar bone portion 20. The alveolar bone portion 20 has an alveolar bone side attachment surface 25 that is removably attachable to the tooth base portion 10 and that is provided with alveolar bone side step portions 21.

The alveolar bone side step portion 21 is provided corresponding to the depth of the insertion hole 23 formed in the alveolar bone portion 20. That is, the longer the root portion 42 of the model tooth 40 to be inserted is, the more the alveolar bone side step portion 21 provided below the insertion hole 23 protrudes. In other words, the shorter the root portion 42 of the model tooth 40 to be inserted is, the more the alveolar bone side step portion 21 provided below the insertion hole 23 is dented.

Specifically, the alveolar bone side step portions 21 are bilaterally symmetrical, and include eight steps on each of the right and left sides, i.e., 16 steps in total.

The eight alveolar bone side step portions 21 on each of the right and left sides include an alveolar bone side central incisor step portion 21a, an alveolar bone side lateral incisor step portion 21b protruding (raised) with respect to the alveolar bone side central incisor step portion 21a, an alveolar bone side canine step portion 21c protruding with respect to the alveolar bone side lateral incisor step portion 21b, an alveolar bone side first premolar step portion 21d dented with respect to the alveolar bone side canine step portion 21c, an alveolar bone side second premolar step portion 21e protruding with respect to the alveolar bone side first premolar step portion 21d, an alveolar bone side first molar step portion 21f protruding with respect to the alveolar bone side second premolar step portion 21e, an alveolar bone side second molar step portion 21g dented with respect to the alveolar bone side first molar step portion 21f, and an alveolar bone side third molar step portion 21h dented with respect to the alveolar bone side second molar step portion 21g in this order from the front side.

The above-described raised and recessed portions of the tooth base side step portions 11 correspond to the recessed and raised portions of the alveolar bone side step portions 21. That is, for the same tooth, the tooth base side step portion 11 is raised in a case where the alveolar bone side step portion 21 is recessed, and is recessed in a case where the alveolar bone side step portion 21 is raised.

The alveolar bone side step portion 21 of the alveolar bone portion 20 is mounted on the tooth base side step portion 11 of the tooth base portion 10. That is, the alveolar bone side central incisor step portion 21a dented with respect to the right and left alveolar bone side lateral incisor step portions 21b is mounted on the tooth base side central incisor step portion 11a protruding with respect to the right and left tooth base side lateral incisor step portions 11b. The alveolar bone side lateral incisor step portion 21b protruding with respect to the alveolar bone side central incisor step portion 21a is mounted on the tooth base side lateral incisor step portion 11b dented with respect to the tooth base side central incisor step portion 11a. The alveolar bone side canine step portion 21c protruding with respect to the alveolar bone side lateral incisor step portion 21b is mounted on the tooth base side canine step portion 11c dented with respect to the tooth base side lateral incisor step portion 11b. The alveolar bone side first premolar step portion 21d dented with respect to the alveolar bone side canine step portion 21c is mounted on the tooth base side first premolar step portion 11d protruding with respect to the tooth base side canine step portion 11c. The alveolar bone side second premolar step portion 21e protruding with respect to the alveolar bone side first premolar step portion 21d is mounted on the tooth base side second premolar step portion 11e dented with respect to the tooth base side first premolar step portion 11d. The alveolar bone side first molar step portion 21f protruding with respect to the alveolar bone side second premolar step portion 21e is mounted on the tooth base side first molar step portion 11f dented with respect to the tooth base side second premolar step portion 11e. The alveolar bone side second molar step portion 21g dented with respect to the alveolar bone side first molar step portion 21f is mounted on the tooth base side second molar step portion 11g protruding with respect to the tooth base side first molar step portion 11f. The alveolar bone side third molar step portion 21h dented with respect to the alveolar bone side second molar step portion 21g is mounted on the tooth base side third molar step portion 11h protruding with respect to the tooth base side second molar step portion 11g.

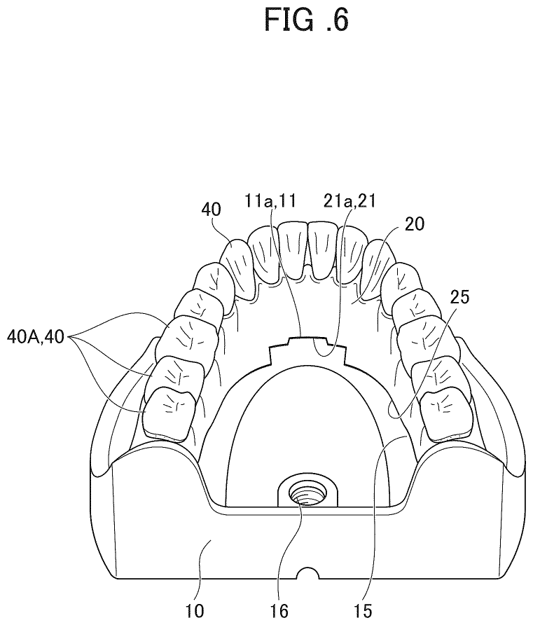

FIG. 6 is a view showing a state in which the alveolar bone portion 20 is mounted on the tooth base portion 10. When the alveolar bone portion 20 is mounted on the tooth base portion 10, the alveolar bone side step portions 21 of the alveolar bone portion 20 are mounted on the tooth base side step portions 11 of the tooth base portion 10. In a case where the alveolar bone side step portion 21 is recessed, the tooth base side step portion 11 on which such an alveolar bone side step portion 21 is to be mounted is raised. In a case where the alveolar bone side step portion 21 is raised, the tooth base side step portion 11 on which such an alveolar bone side step portion 21 is to be mounted is recessed. Thus, if the alveolar bone side step portion 21 and the tooth base side step portion 11 are misaligned with each other, these portions cannot be fitted in each other, and only in a case where the alveolar bone side step portion 21 and the tooth base side step portion 11 are aligned with each other as shown in FIG. 6, does the alveolar bone portion 20 fit in the tooth base portion 10.

### (Gum Portion 30)

The gum portion 30 shown in FIG. 3 is formed of a flexible member. The gum portion 30 is removably attachable to the alveolar bone portion 20, and when attached to the alveolar bone portion 20, covers the outer surface of the alveolar bone portion 20. Further, the gum portion 30 is provided with a plurality of insertion through-holes 33 at positions overlapping with the openings of the insertion holes 23 when attached to the alveolar bone portion 20.

### (Model Tooth 40)

The model tooth 40 is directly removably attachable to the insertion hole 23 in a state where the gum portion 30 is not attached to the alveolar bone portion 20, and is removably attachable to the insertion hole 23 via the insertion through-hole 33 of the gum portion 30 in a state where the gum portion 30 is attached to the alveolar bone portion 20.

The model tooth 40 has a crown portion 41 exposed through the insertion hole 23 and the root portion 42 inserted into the insertion hole 23 when inserted into the insertion hole 23.

### (Crown Portion 41)

The crown portion 41 is a portion exposed through the gum portion 30 in a state where the model tooth 40 is inserted into the insertion hole 23 of the alveolar bone portion 20.

### (Root Portion 42)

The root portion 42 is a portion inserted into the insertion hole 23 and covered with the alveolar bone portion 20 and the gum portion 30 in a state where the model tooth 40 is fixed to the alveolar bone portion 20.

The model teeth 40 include the bifurcated model tooth 40A having a root portion 42 that bifurcates into two branch root portions to be inserted into the branch holes as in an actual tooth. As shown in FIG. 5, the thickest one 42a of the branch root portions of one bifurcated model tooth 40A is provided with the screw hole 43 which extends from the tip end to the crown portion 41 side and is provided with a thread groove in the inner surface. As shown in FIG. 3, the tooth fixing screw 17 is inserted into the screw insertion through-hole 12 from below the tooth base portion 10, and is screwed into the screw hole 43 provided in the model tooth 40 attached to the alveolar bone portion 20. In this manner, the model tooth 40 is fixed to the tooth base portion 10 in a state of being attached to the alveolar bone portion 20.

When inserted into the insertion hole 23 in a state of the gum portion 30 covering the alveolar bone portion 20, the root portion 42 is not exposed to the outside, but is covered with the gum portion 30. However, when the root portion 42 is inserted into the insertion hole 23 in a state of the alveolar bone portion 20 being not covered with the gum portion 30, part of the root portion 42 on the crown portion 41 side is exposed to the outside.

The length of the root portion 42 corresponds to the length of the root portion 42 of the actual tooth. The model teeth 40 corresponding to the first molar, the second molar, and the third molar have the crown portions 41 and the root portions 42 differing in color from each other. In the embodiment, the crown portion 41 is milky white in color, and the root portion 42 is more yellowish than the crown portion 41.

### (Tongue Portion 50)

As shown in FIG. 3, a screw hole 51 is provided in a rear portion of the tongue portion 50. A tongue fixing screw 52 is inserted into the screw hole 51 from above, and is screwed into a tongue fixing screw hole 16 provided for the tongue fixing screw 52 in the tooth base portion 10. In this manner, the tongue portion 50 can be fixed to the tooth base portion 10 with the gum portion 30 interposed therebetween.

### (Upper Dental Model 1U)

Next, the upper dental model 1U will be described. The same reference numerals are used to represent elements similar to those of the lower dental model 1D, and description thereof will be omitted.

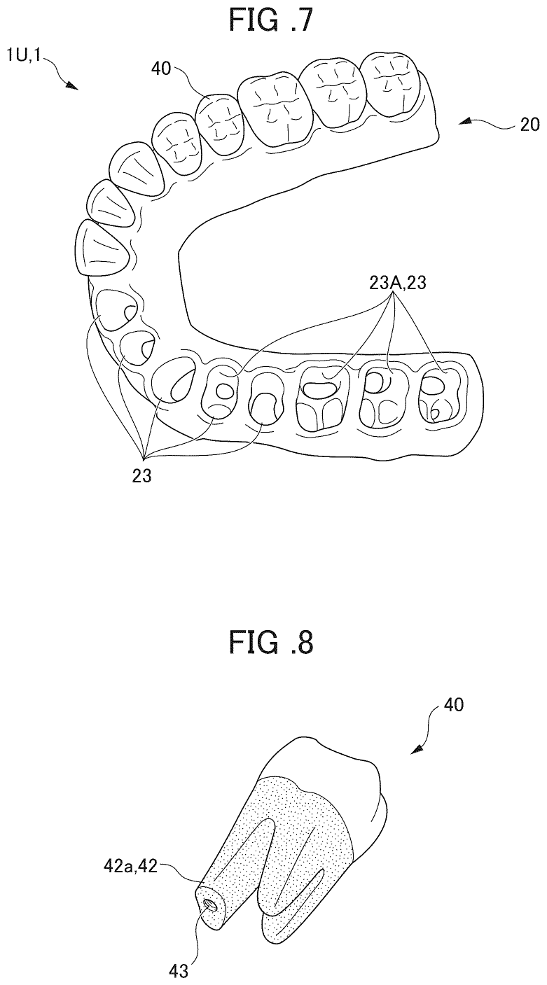

FIG. 7 is a top perspective view of the alveolar bone portion 20 of the upper dental model 1U, and shows a state in which the model teeth 40 are attached on the left side as viewed from the front, but no model teeth 40 are attached on the right side. The upper dental model 1U includes the bifurcated insertion holes 23A as in the lower dental model 1D, but is different from the lower dental model 1D in that these holes include one with two branch holes and one with three branch holes. The insertion holes 23 into which the model tooth 40 of the first molar, the model tooth 40 of the second molar, and the model tooth 40 of the third molar are to be inserted are the bifurcated insertion holes 23A bifurcated into three branch holes, and the insertion hole 23 into which the model tooth 40 of the canine is to be inserted is the bifurcated insertion hole 23A bifurcated into two branch holes.

FIG. 8 is a perspective view showing, as an example, the model tooth 40 of the first molar in the upper dental model 1U among the model tooth 40 of the first molar, the model tooth 40 of the second molar, and the model tooth 40 of the third molar. The root portion 42 of the model tooth 40 of the first molar, which is the bifurcated model tooth 40A, is bifurcated into three branch root portions to be inserted into three branch holes, and the thickest one 42a of the branch root portions is provided with the screw hole 43 which extends from the tip end to the crown portion 41 side and is provided with a thread groove in the inner surface. The tooth fixing screw 17 is screwed into the screw hole 43, and in this manner, the model tooth 40 is fixed to the tooth base portion 10 with the alveolar bone portion 20 interposed therebetween.

According to the embodiment described above, the following features and advantageous effects are obtained.

The alveolar bone portion 20 is removably attachable to the tooth base portion 10, and the gum portion 30 is removably attachable to the alveolar bone portion 20. Thus, in addition to the alveolar bone portion 20 and the gum portion 30 in a normal state, plural types of alveolar bone portions 20 and gum portions 30 in a partially-deformed state or a partially-receded state can be prepared, and these portions are replaceable according to, e.g., a lesion.

In the embodiment, the root portion 42 of, e.g., the model tooth 40 of the molar is bifurcated into the two branch root portions to be inserted into the branch holes as in an actual tooth root.

Thus, in a case where the alveolar bone portion 20 or the gum portion 30 is replaced with one deformed or receded partially according to the lesion, the exposed root portion 42 is close to the state of the root of the actual tooth.

Consequently, for example, in a case of providing practical training for gum disease in a dental educational institution (dental university, hygienist school, dental technician school), a dental clinic, or a dental seminar, such practical training is close to a clinical situation.

At least one of the branch holes in the insertion hole 23 of the alveolar bone portion 20 is the through-hole 231. At least one of the branch root portions of the model tooth 40 to be inserted into the through-hole 231 is provided with the screw hole 43 which extends from the tip end to the crown portion 41 side. The screw insertion through-hole 12 is provided at the position corresponding to the through-hole 231 in the tooth base portion 10. The tooth fixing screw 17 can be inserted into the screw insertion through-hole 12 from the back of the tooth base portion 10, and can be screwed into the screw hole 43 of the model tooth 40.

Thus, each model tooth 40 can be fixed to the tooth base portion 10 and the alveolar bone portion 20 with no influence on the appearance of the model tooth 40. Moreover, each model tooth 40 is individually removably attachable to the tooth base portion 10 and the alveolar bone portion 20.

The branch root portion of one model tooth 40 provided with the screw hole 43 is the thickest one of the branch root portions of the model tooth 40. Thus, the tooth fixing screw 17 can be easily formed.

The alveolar bone side attachment surface 25 of the alveolar bone portion 20 to be attached to the tooth base portion 10 is provided with the alveolar bone side step portions 21, and the tooth base side attachment surface 15 of the tooth base portion 10 to be attached to the alveolar bone portion 20 is provided with the tooth base side step portions 11 in which the alveolar bone side step portions 21 are to be fitted. The raised and recessed portions of the tooth base side step portions 11 correspond to the recessed and raised portions of the alveolar bone side step portions 21. That is, for the same tooth, the tooth base side step portion 11 is raised in a case where the alveolar bone side step portion 21 is recessed, and is recessed in a case where the alveolar bone side step portion 21 is raised.

When the alveolar bone portion 20 is mounted on the tooth base portion 10, the alveolar bone side step portions 21 of the alveolar bone portion 20 are mounted on the tooth base side step portions 11 of the tooth base portion 10. In a case where the alveolar bone side step portion 21 is recessed, the tooth base side step portion 11 on which such an alveolar bone side step portion 21 is to be mounted is raised. In a case where the alveolar bone side step portion 21 is raised, the tooth base side step portion 11 on which such an alveolar bone side step portion 21 is to be mounted is recessed. Thus, if the alveolar bone side step portion 21 and the tooth base side step portion 11 are misaligned with each other, these portions cannot be fitted in each other, and only in a case where the alveolar bone side step portion 21 and the tooth base side step portion 11 are aligned with each other as shown in FIG. 6, does the alveolar bone portion 20 fit in the tooth base portion 10. Thus, the alveolar bone portion 20 can be positioned on the tooth base portion 10, and can be stably attached to the tooth base portion 10.

The length of the root portion 42 of the model tooth 40 corresponds to the length of the root portion 42 of the actual tooth, the depth of the insertion hole 23 of the alveolar bone corresponds to the root portion 42 to be inserted thereinto, and the alveolar bone side step portion is provided corresponding to the depth of the insertion hole 23. Thus, the alveolar bone side step portion can be efficiently provided while the shape of the actual tooth is maintained.

The model tooth 40 is configured such that the crown portion 41 and the root portion 42 are different in color to each other. Thus, for example, in a case of reproducing a situation where the gum portion 30 or the alveolar bone portion 20 is receded due to gum inflammation or alveolar pyorrhea and the root portion 42 is exposed the root portion 42 can be clearly distinguished from the crown portion 41. Thus, e.g., dental training can be easily provided.

### EXPLANATION OF REFERENCE NUMERALS

1 Dental Model
1D Lower Dental Model
1U Upper Dental Model
10 Tooth Base Portion
11 Tooth Base Side Step Portion
15 Tooth Base Side Attachment Surface
20 Alveolar Bone Portion
21 Alveolar Bone Side Step Portion
23 Insertion Hole
23A Bifurcated Insertion Hole
23B Non-Bifurcated Insertion Hole
25 Alveolar Bone Side Attachment Surface
30 Gum Portion
33 Insertion Through-Hole
40 Model Tooth
40A Bifurcated Model Tooth
41 Crown Portion
42 Root Portion
42a Branch Root Portion

1. A dental model comprising:
a tooth base portion;
an alveolar bone portion configured to be removably attachable to the tooth base portion and provided with a plurality of insertion holes;
a gum portion configured to be removably attachable to the alveolar bone portion and provided with a plurality of insertion through-holes at positions overlapping with openings of the insertion holes when the gum portion is attached to the alveolar bone portion; and
a plurality of model teeth configured to be removably attachable to the insertion holes through the insertion through-holes in a state where the gum portion is attached to the alveolar bone portion and, when inserted into the insertion holes, the plurality of model teeth have crown portions exposed through the insertion holes and root portions inserted into the insertion holes,
wherein the plurality of insertion holes includes a bifurcated insertion hole bifurcated into a plurality of branch holes, and
the model teeth include a bifurcated model tooth including a root portion that is bifurcated into a plurality of branch root portions to be inserted into the branch holes.

2. The dental model according to claim 1, wherein
at least one of the branch holes in at least one of the insertion holes is a through-hole,
at least one of the branch root portions of the bifurcated model tooth, to be inserted into the through-hole is provided with a screw hole which extends from a tip end to a crown portion side,
a screw insertion through-hole is provided in the tooth base portion at a position corresponding to the through-hole, and
a screw is screwable into the screw hole from a back of the tooth base portion through the screw insertion through-hole.

3. The dental model according to claim 2, wherein
the at least one of the branch root portions of the bifurcated model tooth, provided with the screw hole is a thickest one of the branch root portions of the bifurcated model tooth.

4. The dental model according to claim 1, wherein
the alveolar bone portion has an alveolar bone side attachment surface to be removably attached to the tooth base portion, the alveolar bone side attachment surface being provided with an alveolar bone side step portion, and
the tooth base portion has a tooth base side attachment surface to which the alveolar bone portion is to be removably attached, the tooth base side attachment surface being provided with a tooth base side step portion in which the alveolar bone side step portion is to be fitted.

5. The dental model according to claim 4, wherein
a length of the root portion of each model tooth corresponds to a length of a root portion of an actual tooth,
a depth of each insertion hole of the alveolar bone portion corresponds to a length of the root portion to be inserted thereinto, and
the alveolar bone side step portion is provided corresponding to the depth of the each insertion hole.

6. The dental model according to claim 1, wherein
each model tooth is configured such that the crown portion and the root portion differ in color from each other.
